(19) United States
(12) Patent Application Publication
(10) Pub. No.: US 2015/0102183 A1
(43) Pub. Date: Apr. 16, 2015

(54) WIRE HARNESS FIXTURE AND METHOD OF PRODUCING WIRE HARNESS WITH FIXTURE HAVING WIRE HARNESS FIXTURE ATTACHED THERETO

(71) Applicant: SUMITOMO WIRING SYSTEMS, LTD., Mie (JP)

(72) Inventor: Yoshihisa YAMAGUCHI, Mie (JP)

(73) Assignee: SUMITOMO WIRING SYSTEMS, LTD., Mie (JP)

(21) Appl. No.: 14/503,693

(22) Filed: Oct. 1, 2014

(30) Foreign Application Priority Data
Oct. 10, 2013 (JP) 2013-212408

(51) Int. Cl. B60R 16/02; F16L 3/12

(52) U.S. Cl. CPC B60R 16/0215; F16L 3/1211
USPC 248/74.3; 29/433

(57) ABSTRACT

A wire harness fixture includes a base having a clip projecting therefrom; a winding band extending and winding around a wire harness from a first end portion of two end portions of the base; and a plurality of engagement portions on a surface of the winding band. The base has a first band insertion hole passing through the two end portions of the base in a direction orthogonal to a projecting direction of the clip, the first band insertion hole having a first engagement projection engaging with the engagement portions of the winding band. The clip and the base have a second band insertion hole passing therethrough in the projecting direction of the clip, the second band insertion hole having a second engagement projection engaging with the engagement portions of the winding band.

### CROSS-REFERENCE TO RELATED APPLICATIONS

The present application claims priority under 35 U.S.C. §119 of Japanese Application No. 2013-212408, filed on Oct. 10, 2013, the disclosure of which is expressly incorporated by reference herein in its entirety.

### BACKGROUND OF THE INVENTION

1. Field of the Invention

The present invention relates to a wire harness fixture attached to an outer periphery of a wire harness such that a projecting clip is fixated to an attachment portion of a vehicle body panel or a vehicle device. The present invention also relates to a method of producing a wire harness with a fixture having the wire harness fixture attached thereto.

2. Description of Related Art

A wire harness fixture is conventionally used to fixate a wire harness routed in a vehicle to an attachment portion of a vehicle body panel or a vehicle device. As disclosed in Japanese Patent Laid-Open Publication No. H8-275346, such a wire harness fixture is integrally provided with a base in a first end portion of a winding band which is wound around a wire harness. The base has a projecting clip fitted to and engaged with an attachment portion, such as a fitting hole, provided in a vehicle body panel or the like. The winding band is inserted through a band insertion hole provided in the base from a second end portion, and then an engagement piece projecting inside the band insertion hole is engaged with an engagement groove of the winding band. Thus, the wire harness can be fastened so as to be incapable of loosening.

Such a wire harness fixture is in broad, general use and is commonly called a “center type,” in which a center axis of the clip passes through substantially the center of the wire harness.

However, in a case where an obstacle is located proximate to the attachment portion of the wire harness fixture or where the wire harness is too thick, the center-type wire harness fixture may cause a problem with attachment. In such cases, the obstacle or the like can be avoided by using a wire harness fixture of what is commonly called an “offset type,” in which the center axis of the clip is not aligned with substantially the center of the wire harness. Such a method, however, requires preparation of two types of wire harness fixtures (center type and offset type) having different wire harness assembly positions, thus leading to an increase in the number of components and the cost.

In view of the above, as disclosed in Japanese Patent Laid-Open Publication No. H9-166245, for instance, a wire harness fixture is proposed in which a center-type wire harness fixture is provided by inserting a fore end portion of a winding band through a center-type band insertion hole, while an offset-type wire harness fixture is provided by inserting the fore end portion of the winding band through an offset-type band insertion hole.

In the wire harness fixture having the structure above, although the fore end portion of the winding band is inserted through different inlets of the band insertion hole in the center type and the offset type, the fore end portion of the winding band projects through a shared outlet of the band insertion hole. This makes misassembly of the center type and offset type extremely difficult to prevent.

In addition, when the offset type of the wire harness fixture having such a structure is used, the wire harness is routed offset toward the fore end portion of the winding band. Thus, a cutter cutting the fore end portion of the winding band after the wire harness is fixated may interfere with the wire harness. This is not an ideal solution.

### SUMMARY OF THE INVENTION

In view of the circumstances above, an advantage of the present invention is to provide a novel wire harness fixture that readily and reliably enables differentiation of a center type and an offset type.

Furthermore, another advantage of the present invention is to provide a method of producing a wire harness with a fixture having the wire harness fixture attached thereto.

An aspect of the present invention provides a wire harness fixture that includes a base having a clip projecting therefrom; a winding band extending and winding around the wire harness from a first end portion of two end portions of the base, which are positioned on two sides with the clip therebetween; and a plurality of engagement portions provided in parallel in an extending direction to a surface of the winding band. The base has a first band insertion hole passing therethrough from the first end portion to a second end portion of the two end portions of the base in a direction orthogonal to a projecting direction of the clip, the first band insertion hole having a first engagement projection engaging with the engagement portions of the winding band. The clip and the base have a second band insertion hole passing therethrough in the projecting direction of the clip, the second band insertion hole having a second engagement projection engaging with the engagement portions of the winding band.

According to the wire harness fixture of the present aspect, the first band insertion hole is provided so as to pass through the base from the first end portion to the second end portion of the two end portions thereof in a direction orthogonal to the projecting direction of the clip. Thus, when the winding band is inserted through the first band insertion hole, a center axis of the clip can be positioned so as to pass through substantially the center of the wire harness. This enables the center type of the wire harness fixture to be used. In addition, the second band insertion hole is provided so as to pass through the clip and the base in the projecting direction of the clip. Thus, when the winding band is inserted through the second band insertion hole, the center axis of the clip can be offset from the center of the wire harness. This enables the offset type of the wire harness fixture to be used.

In summary, the wire harness fixture of the present aspect has both the first band insertion hole and the second band insertion hole, which are provided independently from each other. Thus, by selecting either of the two band insertion holes to insert the winding band, use of the wire harness fixture can be reliably differentiated between the two types (center type or offset type). In particular, the present invention avoids using the same band insertion hole for both the center type and the offset type, as in the conventional structure. Therefore, the use of the wire harness fixture can be differentiated more reliably as compared to the conventional structure, and misassembly can be prevented.

In addition, in the case of offset type use, the wire harness is not routed offset toward the fore end portion side of the winding band. Thus, a cutter cutting the fore end portion of the winding band after the wire harness is fixated is unlikely to interfere with the wire harness.

A further aspect of the present invention provides the wire harness fixture according to the aforementioned aspect, in which a fore end portion of the winding band is inserted through the second band insertion hole from an opening in the base and the fore end portion of the winding band projects outside an opening in the clip.

According to the present aspect, in the case of offset type use, the fore end portion of the winding band project outside the opening in the clip. Thus, when the clip is fixated to an attachment portion of a vehicle body panel or the like, the fore end portion of the winding band can be prevented from projecting toward a wiring space of the wire harness. This can reliably prevent interference of the fore end portion of the winding band with the wire harness, which is likely to occur in the case of offset type use.

Another aspect of the present invention provides a method of producing a wire harness with a fixture having the wire harness fixture according to the aforementioned aspect attached thereto. The method includes setting the wire harness fixture on a jig closing an opening of one of the first band insertion hole and the second band insertion hole; and fastening and fixating the wire harness fixture to the wire harness by placing the wire harness on the wire harness fixture, winding the winding band around the wire harness, and inserting the winding band through the other of the first band insertion hole and the second band insertion hole.

According to the present aspect, the jig that closes the opening of one of the first band insertion hole and the second band insertion hole is used to fasten and fixate the wire harness fixture to the wire harness. Thus, even were an error to be made as to the band insertion hole to which the winding band is to be inserted, fastening and fixating cannot be incorrectly performed since the opening is closed by the jig. This can thus reliably prevent misassembly of the center type and the offset type.

According to the present invention, the wire harness fixture includes both the first band insertion hole and the second band insertion hole, which are provided independently from each other. Thus, by selecting either of the two band insertion holes to insert the winding band, use of the wire harness fixture can be reliably differentiated between the two types (center type or offset type). In particular, the present invention avoids using the same band insertion hole for both the center type and the offset type, as in the conventional structure. Therefore, the use of the wire harness fixture can be differentiated more reliably as compared to the conventional structure, and misassembly can be prevented. In addition, in the case of offset type use, the wire harness is not provided in the offset position on the fore end portion side of the winding band. Thus, a cutter cutting the fore end portion of the winding band after the wire harness is fixated is unlikely to interfere with the wire harness.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a perspective view of a wire harness fixture according to an embodiment of the present invention;

FIG. 2 is an enlarged cross-sectional view along II-II of FIG. 1;

FIG. 3 is a perspective view illustrating a status in which a wire harness is fastened and fixated with the wire harness fixture shown in FIG. 1 (when used as a center type);

FIG. 4 is a front view of FIG. 3;

FIG. 5 is a perspective view illustrating a status in which a wire harness is fastened and fixated with the wire harness fixture shown in FIG. 1 (when used as an offset type);

FIG. 6 is a front view of FIG. 5;

FIG. 7 is a perspective view illustrating a method of producing a wire harness with a fixture having the wire harness fixture shown in FIG. 1 attached thereto (when used as the center type);

FIG. 8 is a front view of FIG. 7;

FIG. 9 is a perspective view illustrating a method of producing a wire harness with a fixture having the wire harness fixture shown in FIG. 1 attached thereto (when used as the offset type); and

FIG. 10 is a front view of FIG. 9.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

Embodiments of the present invention are described below with reference to the drawings.

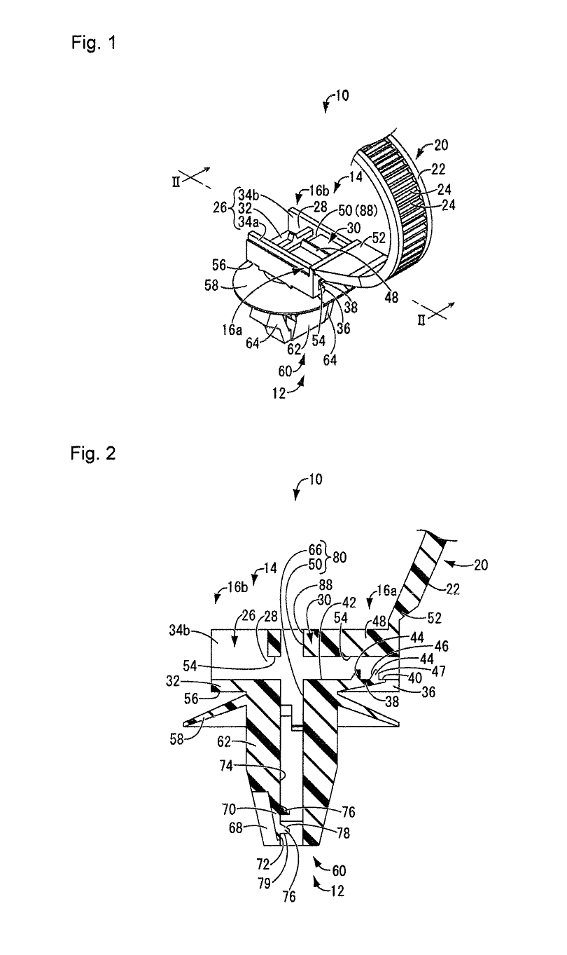

FIGS. 1 and 2 each illustrate a wire harness fixture 10 according to an embodiment of the present invention. With reference to FIG. 1, the wire harness fixture 10 includes a base 14 from which a clip 12 projects, and a winding band 20 extending from a first end portion 16a so as to be wound around a wire harness 18, the first end portion 16a being one of two end portions of the base 14 provided on two sides with the clip 12 therebetween. As is commonly known, the wire harness fixture 10 is integrally formed of a synthetic resin material and the winding band 20 is bendable and deformable. In the description below, upward refers to upward in FIG. 2; downward refers to downward in FIG. 2; forward refers to a left direction in FIG. 2; and rearward refers to a right direction in FIG. 2.

With reference to FIG. 1, the winding band 20 has an elongated flat-plate shape having a rectangular cross-section. A plurality of grooves 24 are provided to a front surface 22 of the winding band 20, the grooves 24 each serving as an engagement portion and each extending linearly in substantially a constant rectangular cross-sectional shape in a width direction. The grooves 24 are provided in parallel with a predetermined distance between one another in an extending direction of the winding band 20. The grooves 24 are configured to have a length that does not reach two width-direction end portions of the winding band 20,

With reference to FIGS. 1 and 2, the base 14 of the wire harness fixture 10 includes a tub-shaped portion 26 and a lid 30, the tub-shaped portion 26 being open upward and extending in a tub shape, the lid 30 covering an opening 28 of the tub-shaped portion 26. The tub-shaped portion 26 extends in the tub shape having a bottom wall 32 and a pair of side walls 34a and 34b standing from two sides of the bottom wall 32. The bottom wall 32 has a cutout portion 36 cut out in substantially a rectangular shape in the first end portion 16a of the two end portions of the base 14. The cutout portion 36 has, in a central portion thereof, an engagement piece 38 having substantially a rectangular shape slightly narrower in width than the cutout portion 36 and projecting rearward a substantially triangular cross-sectional shape. The engagement piece 38 is bendable and deformable in an up/down direction. While an upper surface 40 of the engagement piece 38 is flush with an upper surface 42 of the bottom wall 32 of the tub-shaped portion 26, a first engagement projection 44 projects from the upper surface 40 of the engagement piece 38, the first engagement projection 44 having substantially a trapezoidal cross-sectional shape extending in a direction orthogonal to a projecting direction of the engagement piece 38. In the present embodiment, two first engagement projections 44 are provided with a predetermined distance therebetween in a projecting direction of the engagement piece 38. A front surface 46 of the first engagement projection 44 is a tapered surface projecting gradually upward as the surface inclines rearward, while a rear surface 47 of the first engagement projection 44 is a perpendicular surface standing upright from the engagement piece 38.

The lid 30 is provided in substantially an up/down-direction central portion of the pair of side walls 34a and 34b of the tub-shaped portion 26. The lid 30 is cut away in a second end portion 16b of the two end portions of the base 14. A rib 48 projects from a width-direction central portion of the lid 30 along an entire longitudinal direction of the lid 30, the rib 48 extending in the longitudinal direction in a triangular cross-sectional shape. A through-hole 50 is provided in a front portion of the lid 30, the through-hole 50 being cut out in a substantially rectangular shape along the entire width direction of the lid 30.

The winding band 20 is connected to the first end portion 16a of the two longitudinal-direction end portions of the base 14 via the pair of side walls 34a and 34b of the tub-shaped portion 26 and the rib 48 on the lid 30. The winding band 20 is thinnest at a base end portion 52, which allows the winding band 20 to readily bend at the base end portion 52.

In the base 14 provided as above, a first band insertion hole 54 is defined by the tub-shaped portion 26 and the lid 30. Specifically, the first band insertion hole 54 passes through the base 14 from the first end portion 16a toward the second end portion 16b in a direction orthogonal to the projecting direction of the clip 12 (left/right direction in FIG. 2). The first engagement projection 44 is provided inside the first band insertion hole 54 to engage with the groove 24 of the winding band 20.

The clip 12 projects from a lower surface 56 of the base 14, as shown in FIGS. 1 and 2, to fixate the wire harness 18 to a vehicle body panel, a vehicle device, or the like. The clip 12 includes a disc-shaped dish 58 provided to a projecting base end portion and an engagement head 60 provided to the projecting end portion. The engagement head 60 includes a substantially rectangular engagement pillar 62 and a pair of engagement wings 64 folded back in an arrow shape and projecting from a fore end portion of the engagement pillar 62. The dish 58 is provided so as to come in contact with an attachment portion (not shown in the drawings). The pair of engagement wings 64 are provided so as to be inserted into a clip holding hole of the attachment portion to prevent disengagement.

In a central portion of the clip 12 (specifically, in a position corresponding to the through-hole 50 of the base 14 in the up/down direction in FIG. 2), a through-hole 66 is provided passing through the clip 12 in the projecting direction. A substantially rectangular cutout 68 is provided on a first side (left side in FIG. 2) of the engagement pillar 62, which is the projecting end portion of the clip 12 separated by the through-hole 66. An engagement piece 70 is provided in a central portion of the cutout 68. The engagement piece 70 has a substantially rectangular shape slightly narrower in width than the cutout 68, and projects rearward with a substantially triangular shape in cross section. The engagement piece 70 is bendable and deformable in the left/right direction in FIG. 2. An inner surface 72 of the engagement piece 70 is flush with an inner surface 74 of the through-hole 66. A second engagement projection 76 projects from the inner surface 72 of the engagement piece 70, the second engagement projection 76 having a substantially trapezoidal shape in cross-section and extending in a direction orthogonal to a projecting direction of the engagement piece 70. In the present embodiment, two second engagement projections 76 are provided with a predetermined distance therebetween in the projecting direction of the engagement piece 70. An upper surface 78 of the second engagement projection 76 is a tapered surface projecting gradually rearward as the surface inclines downward. A lower surface 79 of the second engagement projection 76 is a perpendicular surface standing upright from the engagement piece 70.

In the clip 12 and the base 14 of the wire harness fixture 10 provided as above, the through-hole 50 and the through-hole 66 are provided in the projecting direction of the clip 12. Specifically, a second band insertion hole 80 includes the through-hole 50 and the through-hole 66. The second engagement projection 76, which is engaged with the groove 24 of the winding band 20, is provided inside the second band insertion hole 80.

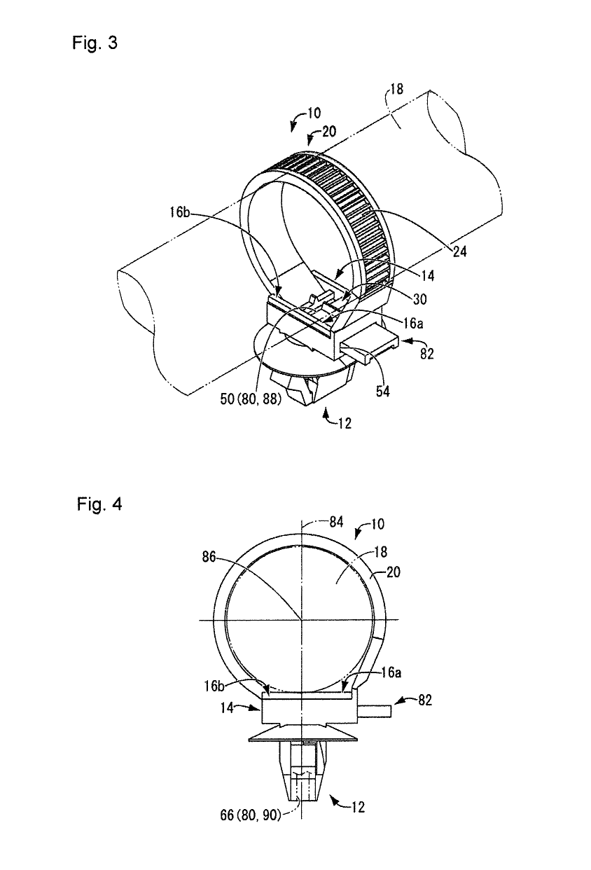

With reference to FIGS. 3 to 6, the wire harness fixture 10 having the structure above is fastened and fixated to the wire harness 18. First, a case where the wire harness fixture 10 is used as the center type is described with reference to FIGS. 3 and 4. After the winding band 20 is wound around the wire harness 18, a fore end portion 82 thereof is inserted through the first band insertion hole 54 from the second end portion 16b toward the first end portion 16a of the base 14. Then, the fore end portion 82 of the winding band 20 is made to project from the first band insertion hole 54 until the winding band 20 is snugly fastened to the wire harness 18. At that time, the first engagement projection 44 is engaged with one of the grooves 24 of the winding band 20. Specifically, since the front surface 46 of the first engagement projection 44 is a tapered surface and the first engagement projection 44 is provided on the engagement piece 38, which is substantially triangular in cross-section and is bendable and deformable in the up/down direction, the winding band 20 can be readily inserted into the first band insertion hole 54. Meanwhile, since the rear surface 47 of the first engagement projection 44 is a perpendicular surface, an engagement function of the first engagement projection 44 relative to the groove 24 of the winding band 20 is exercised only in a direction in which the winding band 20 is pulled out from the first band insertion hole 54, and thus the winding band 20 can be fastened and engaged so as to be incapable of releasing. After the wire harness fixture 10 is fixated, the fore end portion 82 of the winding band 20 is cut off to prevent contact with another component.

Thus, using the wire harness fixture 10 of the present embodiment, the winding band 20 is inserted through the first band insertion hole 54, which passes through the base 14 from the first end portion 16a toward the second end portion 16b in the direction orthogonal to the projecting direction of the clip 12. Thereby, with reference to FIG. 4, a center axis 84 of the clip 12 can be positioned so as to pass through substantially the center 86 of the wire harness 18. This enables the center type of the wire harness fixture 10 to be used.

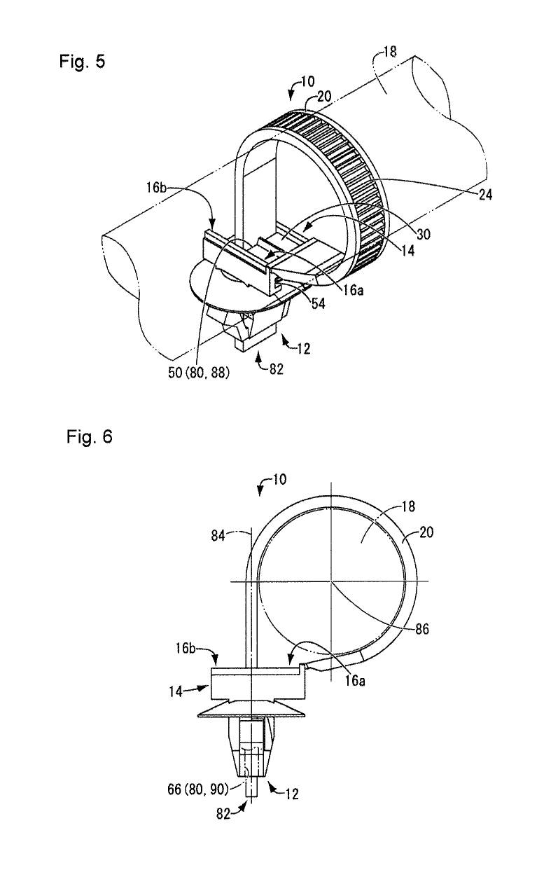

Next, with reference to FIGS. 5 and 6, a case where the wire harness fixture 10 is used as the offset type is described. First, after the winding band 20 is wound around the wire harness 18, the fore end portion 82 thereof is inserted through the second band insertion hole 80 from an opening 88 of the through-hole 50 on the base 14. Then, the fore end portion 82 of the winding band 20 is made to project outside an opening 90 of the through-hole 66 on the clip 12 until the winding band 20 is snugly fastened to the wire harness 18. At this time, the second engagement projection 76 is engaged with one of the grooves 24 of the winding band 20. Specifically, since the upper surface 78 of the second engagement projection 76 is a tapered surface and the second engagement projection 76 is provided on the engagement piece 70, which is substantially triangular in cross-section and is bendable and deformable in the left/right direction, the winding band 20 can be readily inserted into the second band insertion hole 80. Meanwhile, since the lower surface 79 of the second engagement projection 76 is a perpendicular surface, an engagement function of the second engagement projection 76 relative to the groove 24 of the winding band 20 is exercised only in a direction in which the winding band 20 is pulled out from the second band insertion hole 80, and thus the winding band 20 can be fastened and engaged so as to be incapable of releasing. After the wire harness fixture 10 is fixated, the fore end portion 82 of the winding band 20 is cut off to prevent contact with another component.

Thus, using the wire harness fixture 10 of the present embodiment, the winding band 20 is inserted through the second band insertion hole 80, which passes through the clip 12 and the base 14 in the projecting direction to the clip 12. Thereby, with reference to FIG. 6, the center axis 84 of the clip 12 can be offset to one side from the center 86 of the wire harness 18. This enables the offset type of the wire harness fixture 10 to be used.

In addition, the fore end portion 82 of the winding band 20 projects outside the opening 90 on the clip 12. Therefore, when the clip 12 is fixated to the attachment portion of the vehicle body panel or the like, the fore end portion 82 of the winding band 20 is prevented from projecting toward a wiring space of the wire harness 18. This reliably prevents interference of the fore end portion 82 of the winding band 20 with the wire harness 18, which is a circumstance that arises when using an offset type having a conventional structure.

The wire harness fixture 10 of the present embodiment described above has both the first band insertion hole 54 and the second band insertion hole 80, which are provided independently from each other. Thus, by selecting either of the two band insertion holes 54 and 80 to insert the winding band 20, use of the wire harness fixture 10 can be reliably differentiated between the two types (center type and offset type). In particular, the present embodiment avoids using the same band insertion hole for both the center type and the offset type, as in the conventional structure. Therefore, the use of the wire harness fixture 10 can be differentiated more reliably as compared to the conventional structure, and misassembly can be prevented.

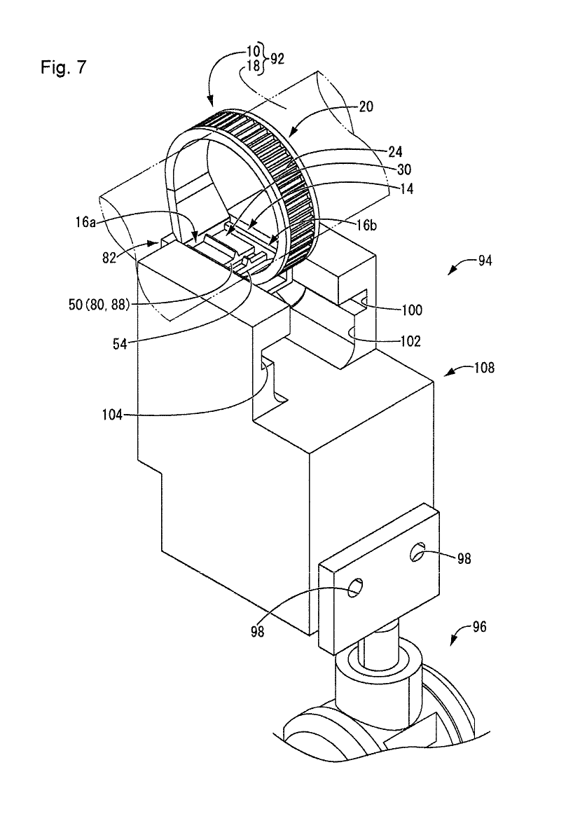

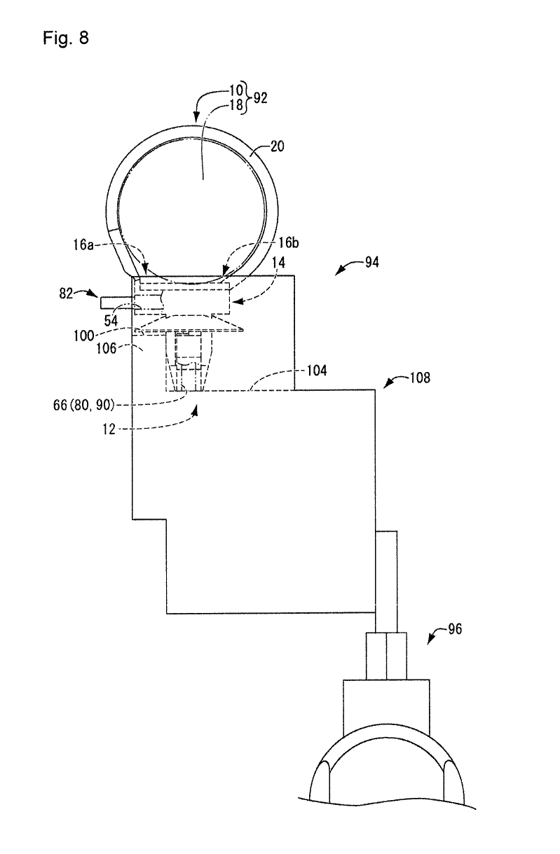

A method of producing a wire harness with a fixture 92 is described below with reference to FIGS. 7 to 10, the wire harness with the fixture 92 having the wire harness fixture 10 of the present embodiment attached thereto. A case where the wire harness fixture 10 is used as the center type is first described in detail with reference to FIGS. 7 and 8. First, a center-type jig 94 is set on a working fixture 96. The working fixture 96 has a through-hole 98, through which a bolt (not shown in the drawings) is inserted to fixate the center-type jig 94 to the working fixture 96. The working fixture 96 can rotate the fixated center-type jig 94 in vertical and lateral directions or move the fixated center-type jig 94 in the up/down direction, for example. Thus, the center-type jig 94 can be adjusted and fixated in a desired orientation and position. The center-type jig 94, which has substantially a block shape, is integrally formed by injection molding or the like with a synthetic resin, such as, for example, polypropylene (PP) or polyamide (PA). A cutout 100 and a cutout 102 are provided to an upper portion of the center-type jig 94. The cutout 100 extends in a longitudinal direction in a constant, substantially inverted-“T” shape in cross section and is open in two directions as well as upward. The cutout 102 extends downward from the cutout 100, extends in the longitudinal direction in a constant, substantially rectangular shape in cross section, and is open rearward. Then, the wire harness fixture 10 is inserted from the first end portion 16a side of the base 14 to a rear opening 104 of the cutouts 100 and 102. The clip 12 of the wire harness fixture 10 is brought into contact with a wall 106 (refer to FIG. 8) provided on a front end portion of the cutout 102, and thus the wire harness fixture 10 is set in a predetermined position. As a result, with reference to FIG. 8, the first end portion 16a of the base 14, which is an outlet of the first band insertion hole 54, can be open whereas the opening 90 on the clip 12, which is an outlet of the second band insertion hole 80, can be closed by a substantially block-shaped lower portion 108 of the center-type jig 94. This completes the setting process, in which the wire harness fixture 10 is set on the jig that closes the outlet of the second band insertion hole 80.

Subsequently, the wire harness 18 is placed on the base 14 of the wire harness fixture 10. After the winding band 20 is wound around the wire harness 18, the fore end portion 82 of the winding band 20 is inserted through the first band insertion hole 54, and thus the wire harness fixture 10 is fastened and fixated to the wire harness 18. This completes the fastening and fixating process. On this occasion, even were the second band insertion hole 80 to be mistaken for the first band insertion hole 54, into which the winding band 20 is to be inserted, fastening and fixating cannot be incorrectly performed since the opening 90 on the clip 12, which is the outlet of the second band insertion hole 80, is closed by the center-type jig 94. This can reliably prevent misassembly of the offset type instead of the center type.

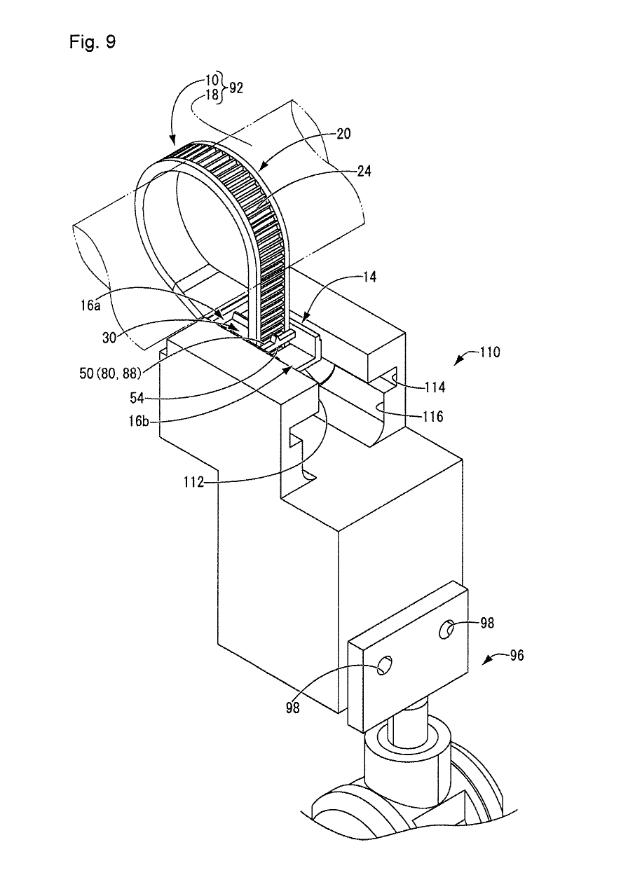

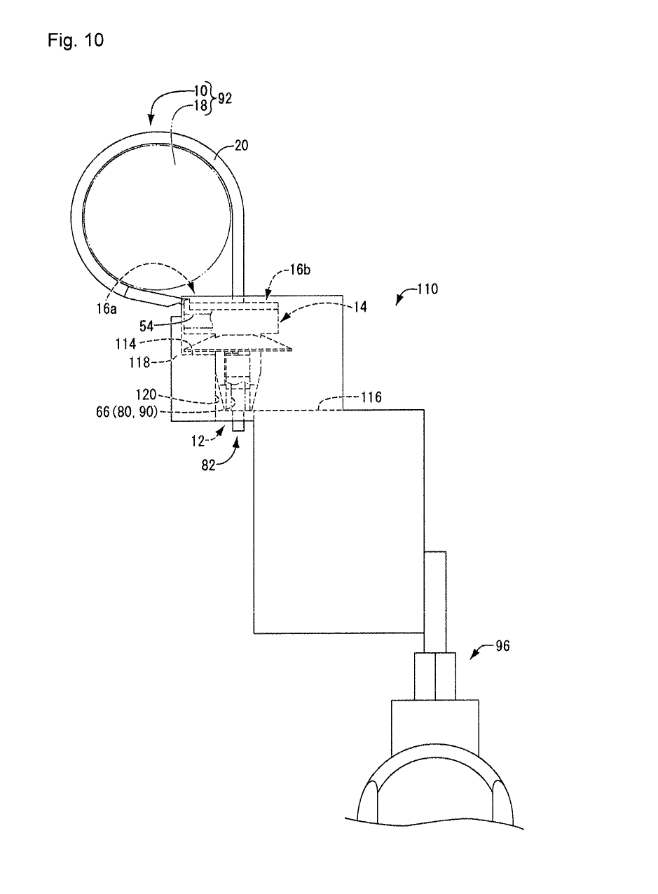

With reference to FIGS. 9 and 10, a case where the wire harness fixture 10 is used as the offset type is described below in detail. First, an offset-type jig 110 is set on the working fixture 96. The offset-type jig 110, which has substantially a block shape, is integrally formed by injection molding or the like with a synthetic resin, such as, for example, polypropylene (PP) or polyamide (PA). A cutout 112 and a cutout 114 are provided to an upper portion of the offset-type jig 110. The cutout 112 extends in the longitudinal direction in a constant, substantially rectangular shape in cross section and is open in two directions as well as upward. The cutout 114 extends downward from the cutout 112, extends in the longitudinal direction in a constant, substantially “T” shape in cross section, and is open rearward. Then, the wire harness fixture 10 is inserted from the first end portion 16a side of the base 14 toward a rear opening 116 of the cutouts 112 and 114. The base 14 and the clip 12 of the wire harness fixture 10 are brought into contact with a wall 118 (refer to FIG. 10) provided on a front end portion of the cutout 114, and thus the wire harness fixture 10 is set in a predetermined position. In addition, a through-hole 120 opening downward is provided to the offset-type jig 110 in a position where the opening 90 on the clip 12 is provided. As a result, with reference to FIG. 10, the opening 90 on the clip 12, which is the outlet of the second band insertion hole 80, can be open whereas the first end portion 16a of the base 14, which is the outlet of the first band insertion hole 54, can be closed by the wall 118 of the offset-type jig 110. This completes the setting process, in which the wire harness fixture 10 is set on the jig that closes the outlet of the first band insertion hole 54.

Subsequently, with reference to FIGS. 9 and 10, the wire harness 18 is placed on the base 14 of the wire harness fixture 10. After the winding band 20 is wound around the wire harness 18, the fore end portion 82 of the winding band 20 is inserted through the second band insertion hole 80, and thus the wire harness fixture 10 is fastened and fixated to the wire harness 18. This completes the fastening and fixating process. On this occasion, even were the first band insertion hole 54 to be mistaken for the second band insertion hole 80, into which the winding band 20 is to be inserted, fastening and fixating cannot be incorrectly performed since the first end portion 16a of the base 14, which is the outlet of the first band insertion hole 54, is closed by the offset-type jig 110. This can reliably prevent misassembly of the center type instead of the offset type.

The embodiment of the present invention described above is merely an example. Specifics of the description of the embodiment should not be construed to limit the present invention. For example, shapes of the engagement pieces 38 and 70 and the engagement projections 44 and 76 are not limited to those presented in the embodiment. Any shape that can fasten and fixate the wire harness fixture 10 to the wire harness 18 may be employed.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A wire harness fixture comprising:
a base having a clip projecting therefrom;
a winding band extending and winding around a wire harness from a first end portion of two end portions of the base, which are positioned on two sides with the clip therebetween;
a plurality of engagement portions provided in parallel in an extending direction to a surface of the winding band;
a first band insertion hole passing through the base from the first end portion to a second end portion of the two end portions of the base in a direction orthogonal to a projecting direction of the clip, the first band insertion hole having a first engagement projection configured to engage with the engagement portions of the winding band; and
a second band insertion hole passing through the clip and the base in the projecting direction of the clip, the second band insertion hole having a second engagement projection configured to engage with the engagement portions of the winding band.

2. The wire harness fixture according to claim 1, wherein a fore end portion of the winding band is inserted through the second band insertion hole from an opening in the base and the fore end portion of the winding band projects outside an opening in the clip.

3. A method of producing a wire harness with a fixture having the wire harness fixture according to claim 1 attached thereto, the method comprising:
setting the wire harness fixture on a jig closing an opening of one of the first band insertion hole and the second band insertion hole; and
fastening and fixating the wire harness fixture to the wire harness by placing the wire harness on the wire harness fixture, winding the winding band around the wire harness, and inserting the winding band through the other of the first band insertion hole and the second band insertion hole.
